(19) United States
(12) Patent Application Publication
(10) Pub. No.: US 2021/0298449 A1
(43) Pub. Date: Sep. 30, 2021

(54) Personal Hygiene Apparatus and Method

(71) Applicant: Shad E. Bruce, San Diego, CA (US)

(72) Inventor: Shad E. Bruce, San Diego, CA (US)

(21) Appl. No.: 17/216,616

(22) Filed: Mar. 29, 2021

Related U.S. Application Data
(60) Provisional application No. 63/000,918, filed on Mar. 27, 2020.

(51) Int. Cl. A45D 27/29; A47K 1/09; G06M 1/28

(52) U.S. Cl. CPC A45D 27/29; G06M 1/286; A47K 1/09

(57) ABSTRACT

A personal hygiene counting device comprising a body portion adapted to be one or both of connected to or disposed on a support structure having one or more of support members for supporting and/or clasping a personal hygiene item and one or more counting elements for counting the usage of a personal hygiene item.

### BACKGROUND

The activity of grooming and shaving are important activities to both men and women who desire to maintain their appearance or certain grooming regimens. Oftentimes a user of a safety razor or razor blade wants to ensure that they are using a sharp razor blade, as a sharp blade provides a much cleaner cut and helps to prevent unwanted conditions that may result from using a dull or worn-out blade. Sometimes, a user of a safety razor will attempt to shave with a dull blade, not remembering how many times the blade has been used. The use of a dull blade will generally result in an uncomfortable shave, creating skin irritation and producing poor results. This is true of disposable razors and those with replaceable razor cartridges. It is not uncommon for consumers to use a combination of electric shavers and manual razors. This may create a longer time interval between manual shaving and adds to the uneasiness of not knowing how many times a blade has been used. Sometimes disposable razor blades or razor blades cartridges provide a lubrication strip which is intended to degrade, decay, and/or break down over time; however, not all razors are include a lubrication strip and in some instances a user may prefer to track their own usage of a razor or simply prefer razors that do not have a lubrication strip.

Thus, there exists a need in the art for a useful and effective apparatus and method for tracking and counting the use of a personal care item such as a single use razor or razor blade cartridge. The present disclosure provides, describes, and discloses an apparatus and method for counting the use of a single-use razor or razor blade cartridge. The apparatus and method of use hereof may address the need by describing a counting or tracking element that may help a user to have a better way of tracking and/or counting the number of times a disposable razor or razor cartridge has been used. The present developments may provide the added benefit of additional features, such as the ability to mount, position, and orient the apparatus on a variety of surfaces and several additional features that may be desirable to a user.

This statement of background is for information purposes only and is not intended to be a complete or exhaustive explication of all potentially relevant background.

### SUMMARY

The present developments relate to a razor blade handle and/or a stand or holder of the razor blade or handle may provide a convenient and effective way for a user to track and count the number of times a razor blade or razor blade cartridge has been used. The developments hereof include a moveable element to track and/or count the use of a personal care item. Furthermore, the developments hereof may include a stand or handle that may be adapted and/or configured to provide several additional features that might be desirable from a user's perspective, such as the ability mount, affix, position, and/or orient the stand or holder to a variety of surfaces including, but not limited to, vertical and horizontal surfaces. Moreover, such a stand or holder hereof may also include one or more of an advertising, display, or branding surface, a collapsible compact mirror, one or more compact storage compartments for shaving related accessories.

Thus, the developments hereof may provide an apparatus and method to track the use of a personal care item by manually moving a designator to the appropriate location. In some respects, the tracking/counting device is a modular handle holder that may be attached to a vertical surface (or horizontal surface) via mounting areas which may utilize Velcro®, double-sided tape, mounting slots, and/or suction cups. In other configurations, the tracking/counting device may be incorporated in to the shaver handle itself. In some implementations, the counting device may be a rotational counting wheel, and yet in others, the counting device may be configured to be a sliding counting element. In either implementation, the counting device may utilize a viewing window, that displays the count or number of times that the razor blade or razor blade cartridge has been used. In one implementation, the user manually must rotate or move the counting device, whether a rotational counting wheel or sliding counting element, to the appropriate and sequentially next position after using the razor or razor blade cartridge. In another implementation, the counting mechanism is configured to move in response to the shaver handle being placed back in the handle holder.

This Summary is neither intended nor should it be construed as being representative of the full extent and scope of the present disclosure. Further, references made herein to “the present disclosure,” or aspects thereof, should be understood to mean certain embodiments of the present disclosure and should not necessarily be construed as limiting all embodiments to a particular description. The present disclosure is set forth in various levels of detail in this Summary, as well as in the Drawings, Detailed Description, and no limitation as to the scope of the present disclosure is intended by either the inclusion or non-inclusion elements. Moreover, the materials, methods, and examples illustrative only and are not intended to be limiting, nor should they be construed as limiting the embodiments. Many features of the implementations hereof may be employed or utilized with or without reference to other features of any of the other embodiments. Additional aspects, features, and alternatives of the present disclosure will be set forth in the Detailed Description, below, and may be apparent from the description, or may be learned by practice of the present disclosure.

Additional features and aspects of the developments hereof will be apparent from the following detailed description and claims.

### BRIEF DESCRIPTION OF THE DRAWINGS

In the drawings:

FIG. 1, which includes FIG. 1A, FIG. 1B, FIG. 1C, FIG. 1D and FIG. 1E, provides plan views, a front elevational view, and a side elevational view of an implementation hereof.

FIG. 2 provides a front elevational view of an implementation hereof.

FIG. 3, which includes FIG. 3A, FIG. 3B, FIG. 3C and FIG. 3D, provides a plan view, a front elevational view, and a side elevational view of an implementation hereof.

FIG. 4 provides a front elevational view of an alternative apparatus hereof.

FIG. 5, which includes FIG. 5A, FIG. 5B, FIG. 5C, and FIG. 5D, provides a plan view, a front elevational view, and a side elevational view of an implementation hereof.

FIG. 6, which includes FIGS. 6A and 6B, provides a front elevational view of an alternative implementation hereof.

FIG. 7 illustrates an additional front elevation view of an alternative shaver holder.

FIG. 8 is a front elevational view of another alternative structure of a shaver holder.

FIG. 9 provides yet another implementation of a shave holder and example of another variety of modifications for counting that may implemented therewith.

FIG. 10 provides a front elevational view of another alternate holder and counter hereof.

FIG. 11 illustrates another front elevational view of yest another shave holder and counting device hereof.

FIG. 12 provides yet another example of an alternative implementation of a shave holder and counter hereof.

FIG. 13 provides yet another example of an alternative implementation of a personal hygiene holding and counting device hereof.

### DETAILED DESCRIPTION

It is to be understood that the present disclosure is not limited in its application to the details of construction and to the embodiments of the components set forth in the following description or illustrated drawings. The figures and written description are provided to teach a person of ordinary skill in the art to make and use the concepts disclosed herein. The present disclosure is capable of other embodiments and of being practiced and implemented in various ways. Persons of skill in the art will appreciate that the development of an actual commercial embodiment incorporating aspects of the present disclosure may require additional implantation-specific choices to provide the end result and commercially practical embodiment.

While the developments hereof are amenable to various modifications and various forms, specifics hereof have been shown herein by way of non-limitative examples in the drawings and the following description. It should be understood and appreciated, however, that the intention is not to limit the developments herein and hereof to the particular embodiments described. The intention is to cover many of the modifications, equivalents, and alternatives falling within the spirit and scope of the inventions and developments whether described here or otherwise being sufficiently appreciable as included herewithin even if beyond the literal words or figures hereof.

In general, included here are multi-function apparatuses related to personal hygiene for counting, tallying, and tracking the use of a personal hygiene item such as a single use razor or razor blade cartridge. Such devices may in many instances be configured for attachment to a variety of surfaces found in a bathroom, including but not limited to, porcelain tile, marble, granite, glass, mirrors, vinyl, drywall, or other solid surfaces that provide a sufficient vertical or horizontal plane for the mounting of the base of the device, utilizing a variety of techniques or manners, such as, suction cups, double-sided tape, Velcro®, high tack adhesive or glue, or mounting screws, bolts, or nails. Such devices may typically be formed of a relatively durable molded plastic product such as high-density polyethylene (HDPE), polyvinyl chloride (PVC), polypropylene (PP), or polycarbonate (PC), or a metal material or composite, or combination and variety thereof. If plastic is used, the various components and elements of the device can be produced via an injection molding process, or other like manufacturing means, however, in other instances, components hereof may be printed using a 3-dimensional printer. If metal, metal composite, or alloy is used for a component, the metal element may be manufactured through the use of a punch and die-metal forming process which may provide for significant precision and increased output.

In one aspect, an apparatus hereof may provide for the securing, holding, and/or storing a personal hygiene product such as a razor blade or razor blade handle; counting, tallying, or tracking the number of uses of a razor blade or razor blade cartridge; and/or attachment components or support components that allow the apparatus to be removably attached or connected to a support surface such as a wall or countertop.

Furthermore, devices hereof may be established to hold or store a personal via one or more support arms which extend away from the base or backer structure. In this way, the one or more support arms provide support for and in some instances clasp the personal hygiene item which is then secured in place with the device. Moreover, the device may include one or more branding or advertising surfaces located on the support base that may allow such a device to be individually branded for promotional or marketing purposes.

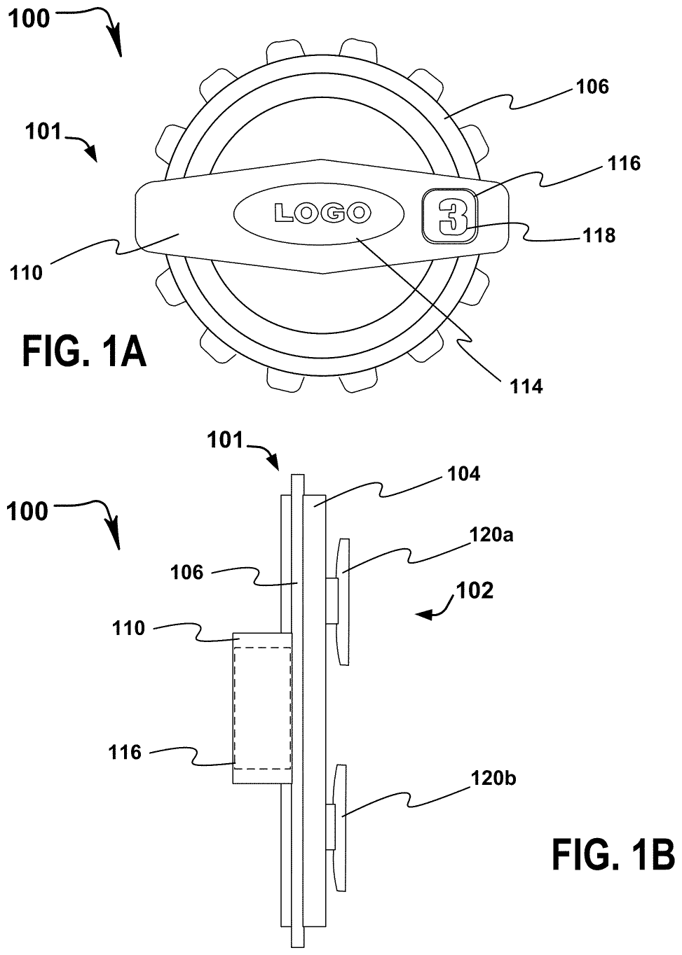

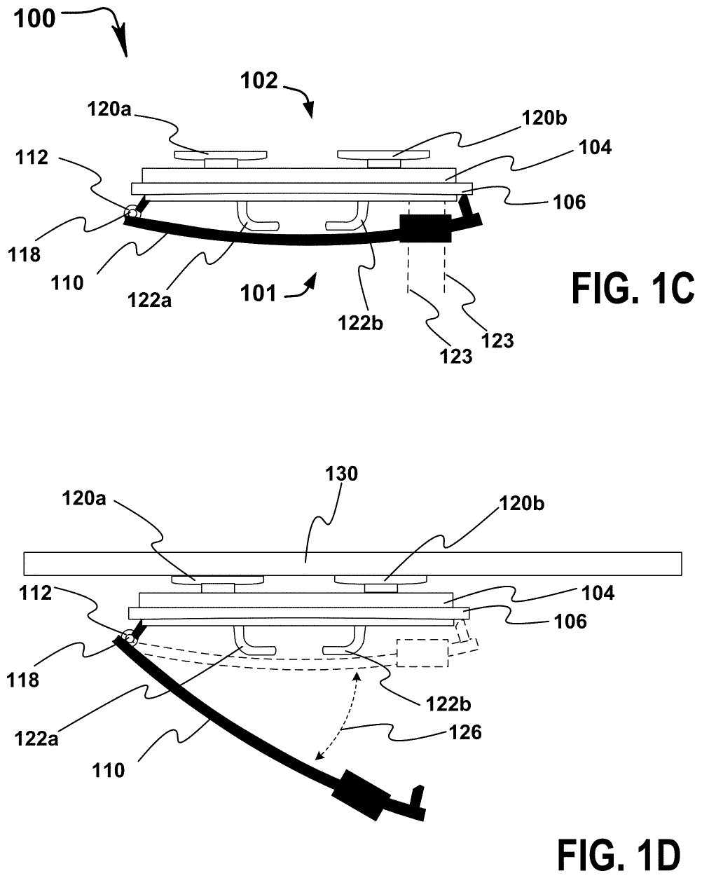

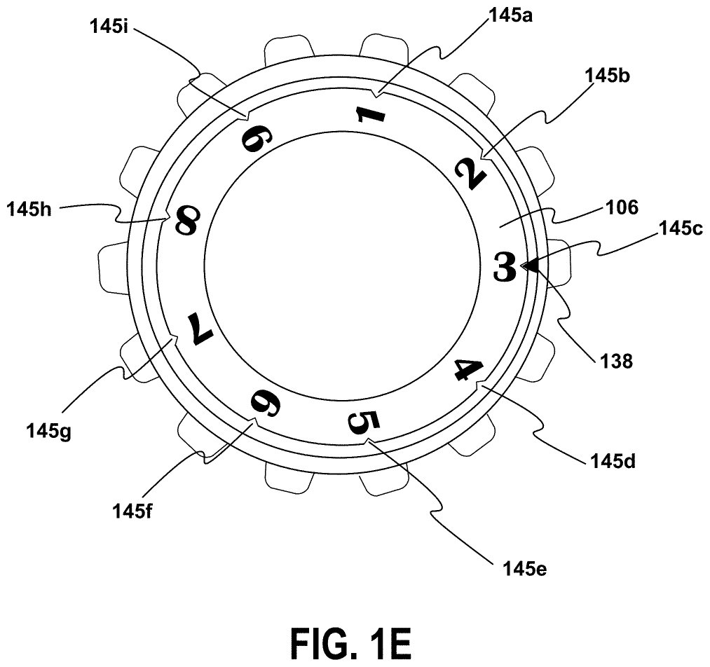

As generally shown in FIG. 1, which is defined by an includes all of sub-part FIGS. 1A-1D, shows an implementation of a device, a personal hygiene counting apparatus 100, which here is shown as a shaver storage apparatus, which may be adapted to be mounted on a variety of surfaces that may be typically found in a bathroom, or other location suitable alternative locations for performing tasks related to personal hygiene. In FIGS. 1A, 1B, 1C, and 1D, a first alternative configuration of a personal hygiene counting apparatus, here a rotational counting wheel 106, is shown. FIG. 1 illustrates a device that has a front side 101 and a mounting side 102, and one body portion 104. The body portion 104 is often fabricated from a relatively thin piece of plastic or metal and may be constructed in a variety of shapes and sizes; however, it may be preferable that the body portion have a flat front side and flat back side, to serve as a base and/or backer and/or support structure, which allows the front side 101 to be configured and adapted to hold or clasp a personal hygiene item and allows the back side 102 to be configured to be mounted to a surface, for the convenience of the user. Furthermore, the apparatus hereof has a front face 110 which may be rotatably connected to the body portion 104. The front face may allow for the front face 110 to be moved relative to body portion 104. In some instances, the front face 110 may be rotatably connected to the body portion 104 via a connection point 112, as shown in FIG. 1C. In other instances, the front face 110 may be completely detached and reattached to the body portion via securing clips that may be formed of resiliently deformable material (not shown in the Figures). The front face 110 may have an advertising panel and/or branding area 114 which may vary in shape and/or size, but in any embodiment provides a surface that may be customized to promote, advertise, or display a logo, brand name, image, slogan, or otherwise desirable material by either a company or an end user. Furthermore, the front face 110 has an aperture or viewing window 116 which is used to display a number, count, or tally 118 when the user adjusts the counting or tallying device.

FIG. 1A provides a front view of a mountable personal hygiene counting apparatus 100. The front side 101 of the body portion is cooperatively connected to the front face 110 via a connection point, such as a hinge 118 shown in FIG. 1C. The rotational counting wheel 106 is rotatably connected to the body portion via a pressure fit piece of molded plastic that allows the rotational counting wheel to snap in to place. The counting wheel 106 is able to be rotated by a user to display a number 118 that is visible through the aperture/viewing window 116 of the front face 110. Note that in some instances the body portion may be obscured from view in a front elevation view of the apparatus, as in FIG. 1A. Generally, the numbers are located on a circular counting wheel that is rotatable. As the rotational counting wheel 106 is spun a usually concealed flexbile tab 138 is distorted slightly and then returns to its original position as it encounters or becomes placed in a series of recessed grooves 145a, 145b, 145c, 145d, 145e, 145f, 145g, 145h, 145i, that correspond to a number on the rotational counting wheel. Each number has a groove associated with as shown in FIG. 1E.

FIG. 1B provides a side elevational view of a device 100 hereof. In this view, the front side 101 and the back side 102 of the body portion 104 are shown. The counting wheel 106 is cooperatively connected to the front side 101 of the body portion 104. The cooperative connection of the counting wheel 106 to the front side 101 of the body portion 104 allows the counting wheel 106 to be rotated by the user to display a number through the aperture/viewing window 116 (indicated by the dashed line in FIG. 1B) which is part of the front face 110. As part of the fabrication process, a number of options could be selected for the number or count to be included in the device 100. For example, the number may include 0, 1, 2, 3, 4, 5, 6, 7, 8, 9, 10, 11, 12, 13, 14, 15, 16, 17, 18, 19, 20, or more numbers.

The one or more mounting areas 120a, 120b extend perpendicularly from the back side 102 of the body portion 104. These mounting areas may provide several options for affixing the device 100 to a surface, including but not limited through suction cups, double-sided tape, Velcro®, high tack adhesive or glue, or mounting screws, bolts, or nails, or in some instances the device may simply be free-standing. The option selected for affixing the device to a surface is primarily dependent on the type of surface that is available to the user. For example, if the available surface is tile, glass, or mirror, one or more suction cups may be the preferred option used to affix the device to the surface. However, if the surface is a textured drywall double-sided tape, mounting bolts, or nails may be the preferred way for attaching and the securing the device to the surface.

FIG. 1C provides a top plan view of a personal hygiene counting apparatus 100 having a body portion 104 that has a front side 101 and a back side 102. From this view, the holding arms 122a/122b that extend substantially perpendicular from the front side are visible. The holding arms 122a/122b are used to hold and/or clasp the personal hygiene item. The holding arms 122a/122b may be shaped in a various ways; however, in one aspect they are curved arms formed of resiliently deformable plastic that allows the personal hygiene item to be both be supported vertically and also held or secured in place on the front side 101 of the device. FIG. 1C further provides a connection point 112 which is the point at which the front face 110 is rotatably connected to the body portion 104 via a hinge 118. The hinge 118 allows the front face to swing away from the device indicated by dashed arrow 126 as shown and described in FIG. 1D. Due to the nature of the plan view of FIG. 1C, the aperture/viewing window of the front face 110 is not visible; however, the dashed lines 123 demonstrate where the aperture/viewing window would provide a line of sight to the counting wheel 106.

FIG. 1D provides an additional top plan view of the personal hygiene counting apparatus 100, which demonstrates how the front face 110 is able to be opened and rotated away from the body portion 104 and counting wheel 106 via hinge 118. Dashed arrow 126 demonstrates how the front face 110 is rotated away from the stationary/fixed body portion 104 and how the mounting areas 120a/120b remain in place relative to the mounting surface 130.

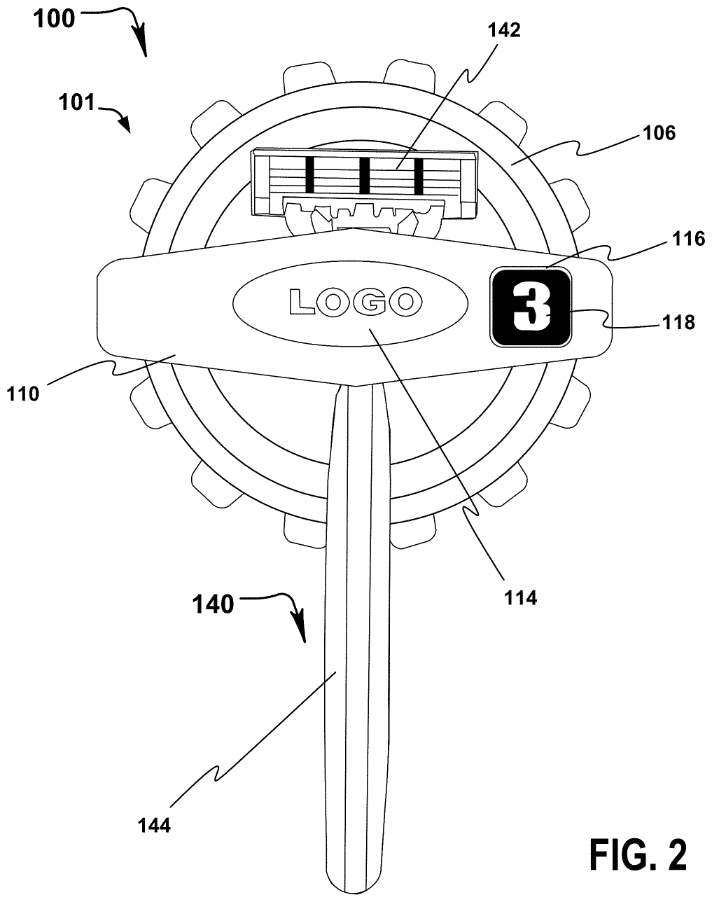

FIG. 2 provides a front elevational view of the personal hygiene counting apparatus 100, which further demonstrates how a shaver 140 may be placed and secured in such a device. Note that the shave cartridge 142 is cooperatively connected to the shaver handle 144. In this closed position, the holding arms are not visible but are supporting and holding the shaver 140 in place. In this view, the front face 110 is in a closed position and a number 118 from the counting wheel 106 is visible through the aperture/viewing window 116. The advertising panel and/or branding area 114 is also readily apparent and easily viewed.

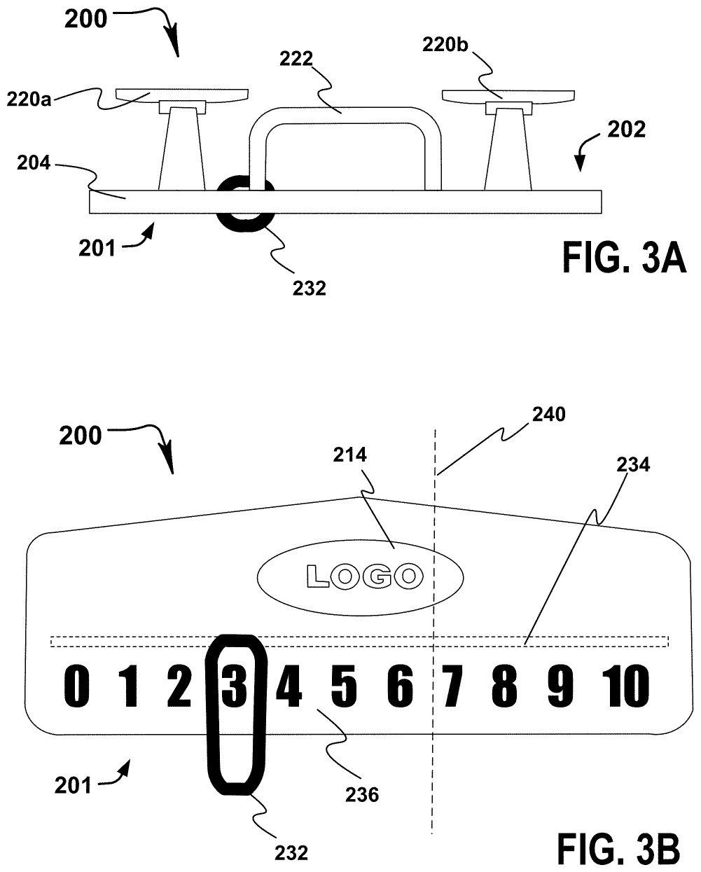

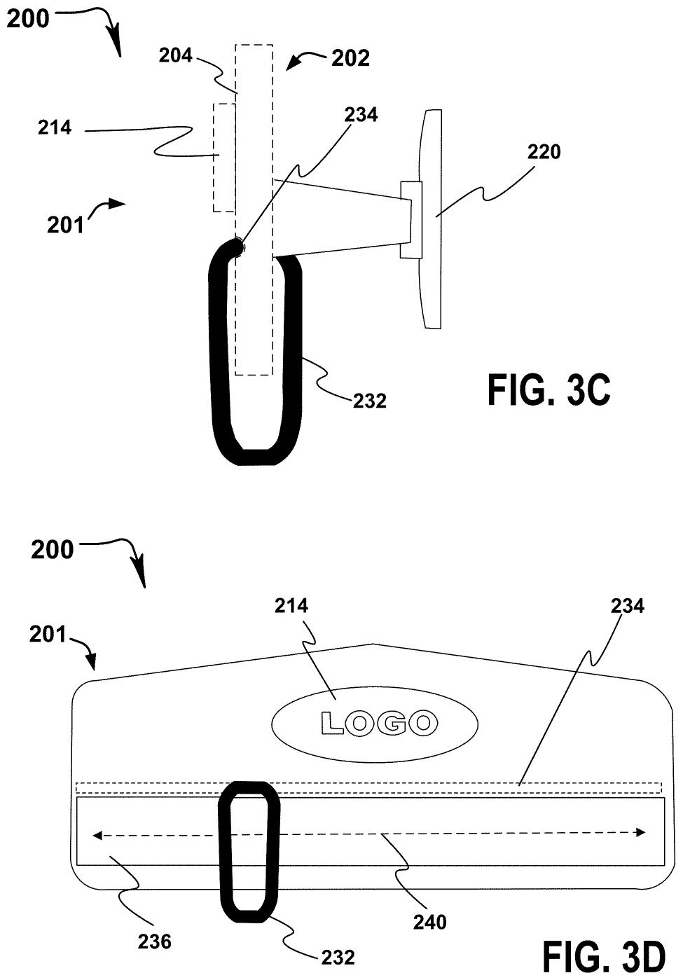

FIG. 3, which is defined by and includes all of sub-part FIGS. 3A-3C, shows an embodiment of a device, a personal hygiene counting apparatus 200, which here is shown as a shaver storage apparatus, which may be adapted to be mounted on a variety of surfaces that may be typically found in a bathroom, or other location suitable alternative locations for performing tasks related to personal hygiene. In FIGS. 3A, 3B, and 3C, an alternative configuration of a personal hygiene counting apparatus, here, a sliding counting element is disclosed and described.

In FIG. 3A, provides a top plan view of a personal hygiene counting apparatus 200. FIG. 3A illustrates a device hereof having a body portion 204 that has a front side 201 and a mounting side/back side 202. In this implementation, the mounting side or back side 202, has one or more mounting areas 220a/220b which extend perpendicular from the back side. The mounting areas 220a/220b are similar to the mounting areas 120a/120b of device 100 of FIGS. 1A-1D. These mounting areas 220a/220b may provide several options for affixing or attaching the the device 200 to a surface, including but not limited through use of suction cups, double-sided tape, Velcro®, high tack adhesive or glue, or mounting screws, bolts, or nails, or in some instances the device may simply be free-standing. As described previously, option selected for affixing the device to a surface is primarily dependent on the type of surface that is available to the user. For example, if the available surface is tile, glass, or mirror, one or more suction cups may be the preferred option used to affix the device to the surface. However, if the surface is a textured or non-textured drywall, or wood, double-sided tape, mounting bolts, or nails may be the preferred way for attaching and the securing the device to the surface.

The personal hygiene counting apparatus 200 may have one or more holding arm(s) or handle(s) 222 that extend perpendicularly from the mounting side/back side 202. The holding arm/handle may perform a similar function to the holding arms 122a/122b of device 100; however, in this implementation, the personal hygiene item, whether a razor or toothbrush, or otherwise, may be supported by the loop created by the holding handle 222 and the body portion 204, rather than clasped and secured by the arms as may be the case with the holding arms 122a/122b of device 100. The size and shape of the holding handle 222 may be varied based on the length and extension of the mounting areas 220a/220b from the back side 202. The mounting areas 220a/220b preferably extend further from the mounting side 202 than any support arms or holding handle 222, thus allowing the mounting areas 220a/220b to be attached and affixed to an immovable structure.

FIG. 3B, provides a front elevational view of the front side 201 of a personal hygiene counting apparatus 200. In this implementation, a sliding element 232, is movably attached to the body portion 204. The sliding element 232 may be attached and allowed to slide horizontally from one end of the body portion 204 to the other. This may be accomplished by a groove/channel 234 in the body portion. This sliding groove/channel 234 may be place along the top or bottom of the number line 236 where the sliding element 232 is intended to slide. Note that the groove/channel stops before the edge of the body portion 204 and this prevents the sliding element from detaching from the body portion 204. Also included in FIG. 3B is an advertising panel and/or branding area 214 which may vary in shape and/or size, but in any embodiment provides a surface that may be customized to promote, advertise, or display a logo, brand name, image, slogan, or otherwise desirable material by either a company or an end user.

FIG. 3C provides a side elevational and partial cut-away view of a personal hygiene counting apparatus 200. In this implementation, the apparatus 200 has a body portion 204 that has a front side 201 and back side 202. One or more mounting areas 220 extend or project perpendicular from the back side/mounting side 202 of the body portion 204. Note, that in FIG. 3C the body portion is shown with a dashed line to indicate that the body portion 204 is cutaway. The body portion is cutaway at approximately the location of the dashed line 240 on FIG. 3B. The front side 201 has an advertising panel and/or branding area 214 which provides a surface that may used to customize, promote, advertise, and/or display a logo, slogan, or other information. FIG. 3C also demonstrates how the sliding element 232 may attach to the body portion 204. In this way, the sliding element (or slider) 232 may be held and supported by the groove 234 but allowed to slide horizontally along the number line when moved by a user.

FIG. 3D provides yet another example of the front side 201 of a personal hygiene counting apparatus 200. In this example, in addition to the logo display area 214, and number line 236, the slider 232 is shown to be capable of sliding in the groove 234 the direction of dashed arrow 240. It is contemplated that any number of numbers could be incorporated in the number line 236, e.g. 1 to 10, 1 to 20, or 1 to 30. As there may be multiple hygiene activities that an individual might like to track or count such as shaving, tooth brushing, or the tracking of taking a pill, or any routine activity that an individual may encounter in their daily routine. As such, it is also contemplate two, three, four, or more number lines, or sliders may be added to such as device. It is contemplated that such a device might be used to help a child or older user track or count an activity and as such, multiple number lines and sliders may be incorporated in to such a device.

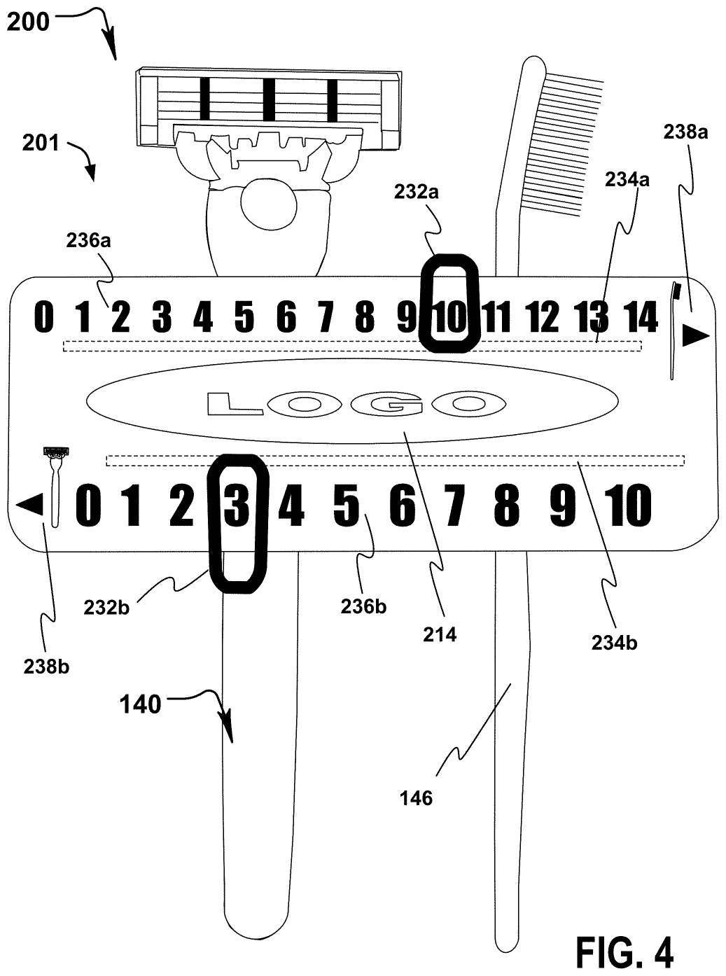

FIG. 4 provides a front elevational view of the personal hygiene counting apparatus 200, which further demonstrates how a shaver 140 and an additional personal item, such as a toothbrush 146, may be placed and secured in such a device. In this implementation as shown in FIG. 4, there may be more than one set of holdings arms or holding handles, which are located on the back side 202 of the apparatus 200; however, neither are visible from the front view as shown in FIG. 4. The front side 201 of device 200 may have two number lines, for example, one number line 236a may be associated with a first personal hygiene item such as a toothbrush 146, and a second, discrete number line 236b may be associated with a second personal hygiene item such as a razor 140. The number lines associated with the first number line may have a different number and count than that of the second number line. For example, as shown in FIG. 4, the number line associated with the toothbrush 146 may number from 1 to 14, yet the number line associated with shaver may number from only 1 to 10. In this aspect, the developments contemplate numerous different person care items that may be used and paired together that may have different number lines to track and count progress and/or usage. In this way, there may be two sliders or sliding elements 232a, 232b that are disposed and associated with the distinct and separate number lines 236a and 236b. Both of the sliding elements 232a, 232b may be disposed and associated with a groove/channel that helps keep the sliding element in operable connection with the body portion 204. Moreover, in this implementation, the body portion again has an advertising panel and/or branding area 214 is also readily apparent and easily viewed. Lastly, this implementation includes an additional feature of an icon and indicator arrow 238a/238b that may be associated with each of the respective personal hygiene items that are stored or held using the device 200. The icon and indicator arrow 238a/238b may help a user hereof to easily identify which side to store the particular item on and also be reminded of which number line 236a/236b relates to each particular personal hygiene item.

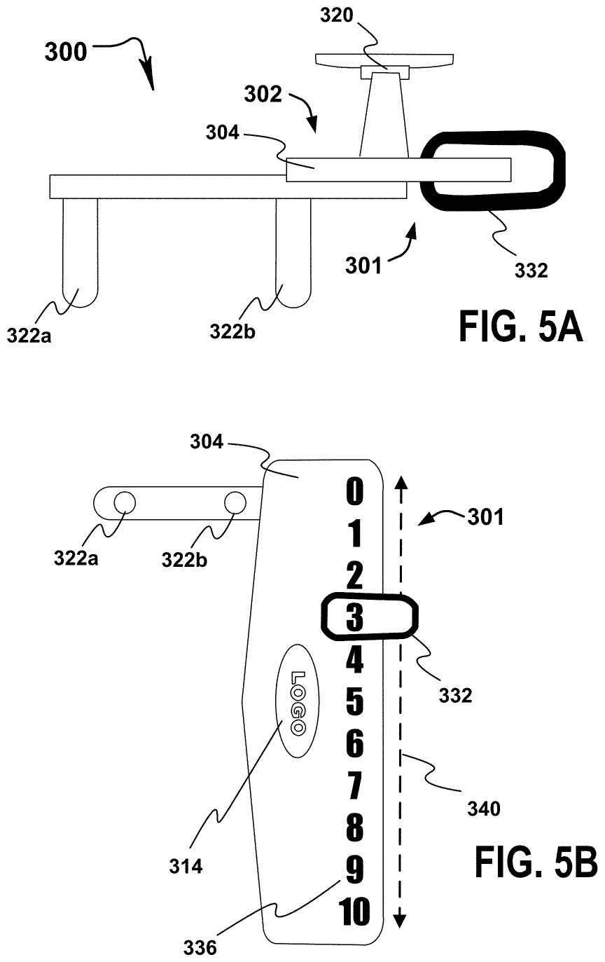

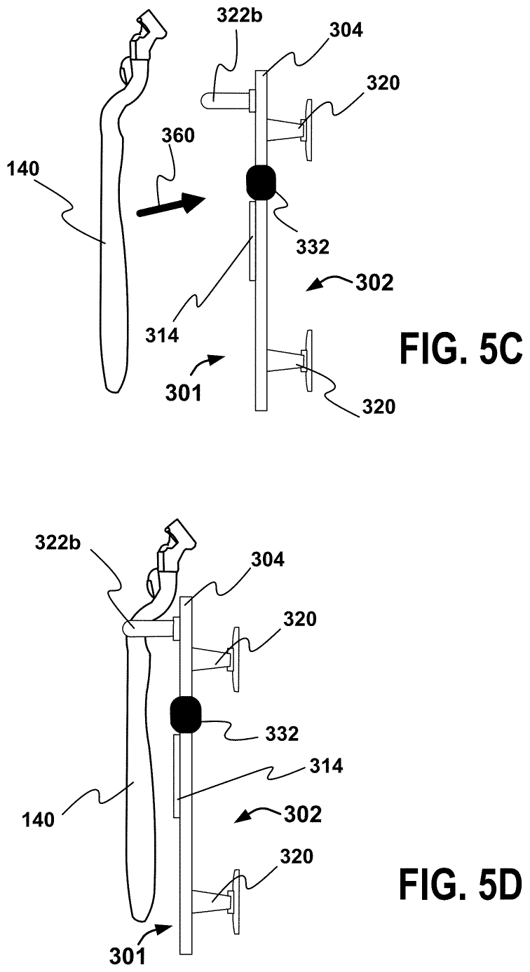

As generally shown in FIG. 5, which is defined by an includes all of sub-part FIGS. 5A-5D, shows an implementation of a device, a personal hygiene counting apparatus 300, which here is shown as a shaver storage apparatus, which may be adapted to be mounted on a variety of surfaces that may be typically found in a bathroom, or other location suitable alternative locations for performing tasks related to personal hygiene. In FIGS. 3A, 3B, 3C, and 3D, a third alternative configuration of a personal hygiene counting apparatus, here a vertical sliding element 332. FIG. 5A illustrates a device 300 has a body portion 304 that has a front side 301 and a mounting side 102. The body portion 304 is often fabricated from a relatively thin piece of plastic or metal, less than approximately 1 cm in thickness and greater than approximately 0.2 cm in thickness, and may be constructed in a variety of shapes and sizes; however, it may be preferable that the body portion have a flat front side and flat back side, to serve as a base and/or backer and/or support structure, which allows the front side 301 to be configured and adapted to hold or clasp a personal hygiene item and allows the back side 302 to be configured to be mounted to a surface, for the convenience of the user.

Furthermore, FIG. 5A provides a top plan view of an exemplar of a device 300 hereof. The holding arms 322a/322b project and extend away perpendicularly from the front side 301 of the body portion 304. The holding arms 322a and 322b may be fabricated from a suitable material that is capable of providing the sufficient strength to support and hold a personal hygiene item such as a razor or toothbrush. One or more mounting areas 320 may extend or project perpendicular or rearward from the backside 302 of the body portion 304. The mounting areas 320 may provide several options for affixing the device 300 to a surface. The mounting areas may be readily adapted to utilize one or more of suction cups, double-sided tape, Velcro®, high tack adhesive or glue, or mounting screws, bolts, or nails. In some instances the mounting areas may simply allow the device to be free standing or rest on a counter top. The option selected for affixing the device to a surface is primarily dependent on the type of surface that is available to the user. Other considerations for attaching or affixing a personal counting hygiene device have been described elsewhere herein.

The device 300 hereof also has a vertical sliding element 332 which is capable of being moved by a user of the device to a position to indicate the number of times that a particular hygiene device has been used by the user. The vertical sliding element 332 is similar to the sliding element 232, disclosed and described in relation to FIG. 3; however, the sliding element 332 of FIG. 3 is designed to move vertically, or along a y-axis in relation to the body portion 304, while the sliding element 232 of FIG. 3 is intended to move horizontally, or along an x-axis in relation to the body portion 204 as shown and described in FIG. 3 above. FIG. 5B provides dashed line 340 which is intended to show that the sliding element 332 is capable of being moved vertically up and down the body portion. It should be noted that the sliding element 332 may be located along the edge of the body portion 304 or may in other implementations be interior to the body portion (not shown in the figures); however, in either case the sliding element 332 is capable of being moved and positioned by the user at different discrete locations along the number line 336. Furthermore, the front side 301 of the body portion 304 also has an advertising panel and/or branding area 314 that may be utilized for branding or advertising purposes as disclosed and described inter alia.

It should be noted that the sliding element 332 of FIG. 5 may utilize a similar groove and/or channel design that allows the sliding element to be slid and repositioned along the number line by a user to track, count, and/or tally the number of uses of the personal hygiene item that the particular user is seeking to track. In some embodiments, the sliding element and corresponding and associated number line may have a series of notches that correspond to a particular and known location on a number line that help the sliding element closely align and identify a particular number such as “3” as shown in FIG. 5B.

FIGS. 5C and 5D provide side elevational views of the device 300 and demonstrate how a personal hygiene item such as a razor 140 may be moved in the direction of arrow 360 and secured to the front side 301 of the device via the holding arms 322a/322b. Due to the view provided in FIG. 5C and FIG. 5D, only holding arm 322b is visible. FIGS. 5C and 5D also show how the mounting areas 320 project and extend away from the body portion 304. The length or distance of the extension of the mounting areas 320 away from the body portion 304 may be as small as to be flush with back side 302 of the body portion 304; however, in other embodiments, the mounting areas may include legs that extend as far as several centimeters or inches away from the back side 302 of the body portion 304. FIGS. 5C and 5D also demonstrate that the advertising or branding logo is located and visible on the front side 301 of the body portion 304.

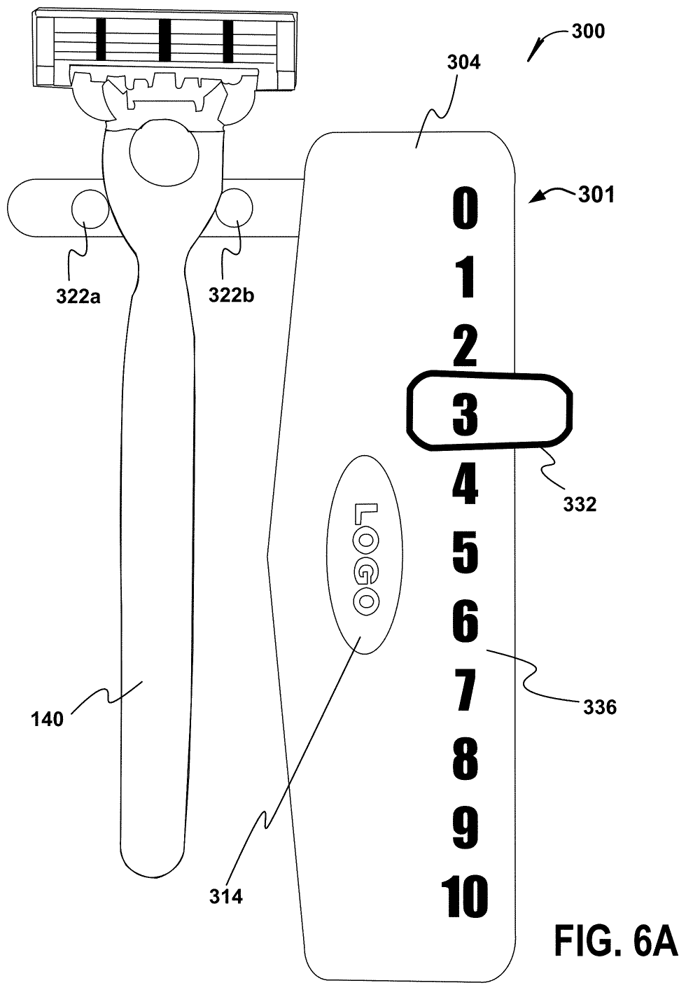

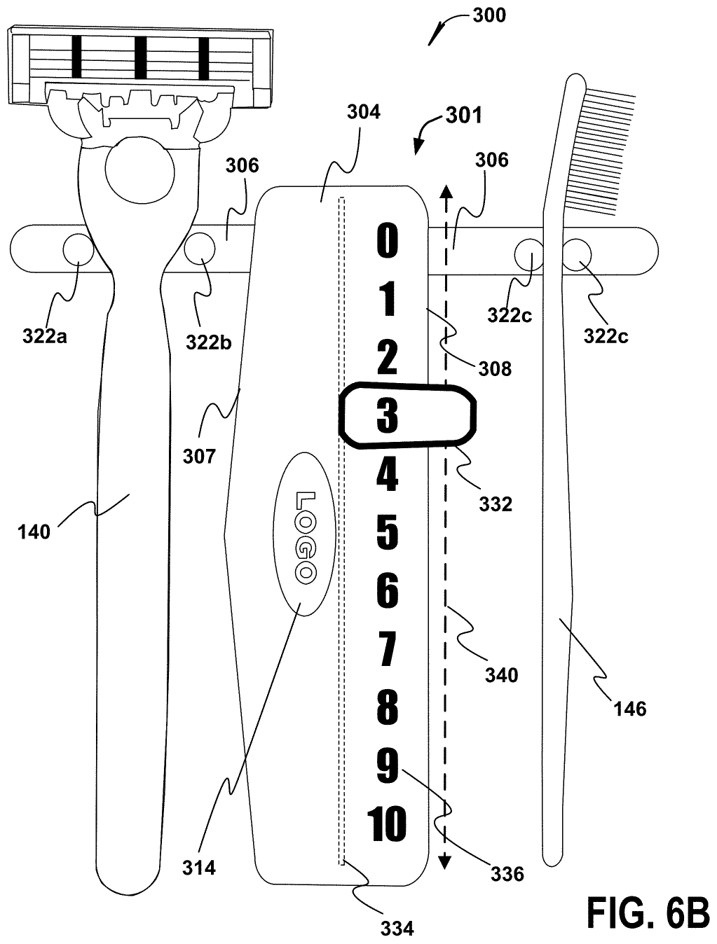

FIG. 6A provides yet another front elevational view of the front side 301 of a device 300 which demonstrates and illustrates how a personal hygiene item, here a razor 140, may be clasped and secured by the holding arms 322a/322b, similar to as shown in FIG. 5D. Further, the body portion 304 has a vertically oriented number line 336 and vertical sliding element 332 which is capable of being moved in a vertical sliding motion. The advertising panel 314 is also shown and displayed on the front side of the device 300.

FIG. 6B provides yet another implementation of a device 300 hereof. In this implementation, the device 300 has a body portion 304 and a front side 301 and a backside 302 (not shown in FIG. 6B). The device 300 may have a horizontal member 306 that is securely connected to the body portion 304 and extends beyond the left side 307 and beyond the right side 308 of the body portion 304. The horizontal member 306 may be and joined with the body portion 304 as unitary body, or alternatively may be discrete member that is joined to the body portion 304 by passing the horizontal member 306 through slots or opening on the left side 307 and right side 308 that allow the horizontal member to pass through the entirety of the body portion. The horizontal member 306 may be secured in place via screws or small bolts. Additionally, the horizontal member 306 may have one or more mounting areas located on the back side that allows the horizontal member to be securely attached to a surface as well.

The horizontal member 306 has holding arms 322a/322b and 322c/322d that are cooperatively connected to the horizontal member that extend perpendicularly therefrom. In one aspect the holding arms 322a/322b/322c/322d are formed of a resiliently deformable plastic which allows them to deform and then return to their original shape. In this way, the holding arms may clasp, clutch, or hold a personal hygiene item, such as a razor 140 or toothbrush 146. In some implementations, the holding arms may be formed of metal or another stiff material. In any event, the holding arms 322a/322b/322c/322d extend outward and away from the horizontal member 306 and provide support to hold the personal hygiene item in a position as shown and described in FIG. 6B inter alia.

The body portion 304 of a device 300 also has a vertical sliding element 332 that is cooperatively connected to the body portion 304 in such a manner as to allow the vertical element to slide. In one aspect, the vertical sliding element 332 may be connected via a friction fit, that is, the vertical sliding element is formed and fashioned in a precise way such that the element maintains some friction between the sliding element and the body portion such that it stays in place once positioned by the user and does not fall to the bottom of the body portion simply due to gravity. In another respect, the vertical sliding element 332 may employ a groove/channel 334 that keeps the vertical sliding element 332 traveling in a straight line along the number line 336 and also stops the vertical sliding element 332 from disconnecting from the body portion 304. The body portion 304 may have one or more grooves/channels 334 that extend vertically for a substantial length of the body portion 304. The grooves/channels 334 may be located on the front side 301 or the back side of the body portion. These grooves/channels help to allow a user to move the vertical sliding element 332 either upward or downward as indicated by dashed double arrowed line 340.

FIG. 7 provides and illustrates yet another implementation of a personal hygiene counting device 400 hereof. In this implementation, the device 400 has a front side 401 and a back side (not shown in FIG. 7). FIG. 7 provides a front elevation view of the device 400 which has a body portion 404 that has a vertically oriented number line 446, a vertical sliding element 432. The vertical sliding element is used to count and/or track the usage of a personal hygiene item such as a shaver 140. The front side 401 has an advertising panel and/or branding area 414 which may vary in shape and/or size, but in any implementation provides a surface that may be customized to promote, advertise, or display a logo, brand name, image, slogan, or otherwise desirable material by either a company or an end user.

Further, the device 400 has horizontal support members 406, 412, and 413 which extend horizontally from the left side 405 and right side 407 of the body portion 404. Holding arms 422a/422b extend outward from the horizontal support member 406. These holding arms may clasp the handle of a razor 140 or may simply exist to hold and support a razor 140. The horizontal support members 412, 413 extend from the right side 407 of the body portion 404 and connect to and securely support a mirror attachment 450. In some embodiments, the mirror may have a frame 451 which serves to protect the user from possible sharp edges of the mirror and may also provide a structure to which the horizontal support members 412 and 413 connect and secure the mirror.

The body portion of the device 400 has a vertical sliding element 432 which is capable of being slid up and down the body portion 404 to different positions along on the vertical number line 446 which allows a user to tally, track, and/or count the number of times a personal hygiene device has been used.

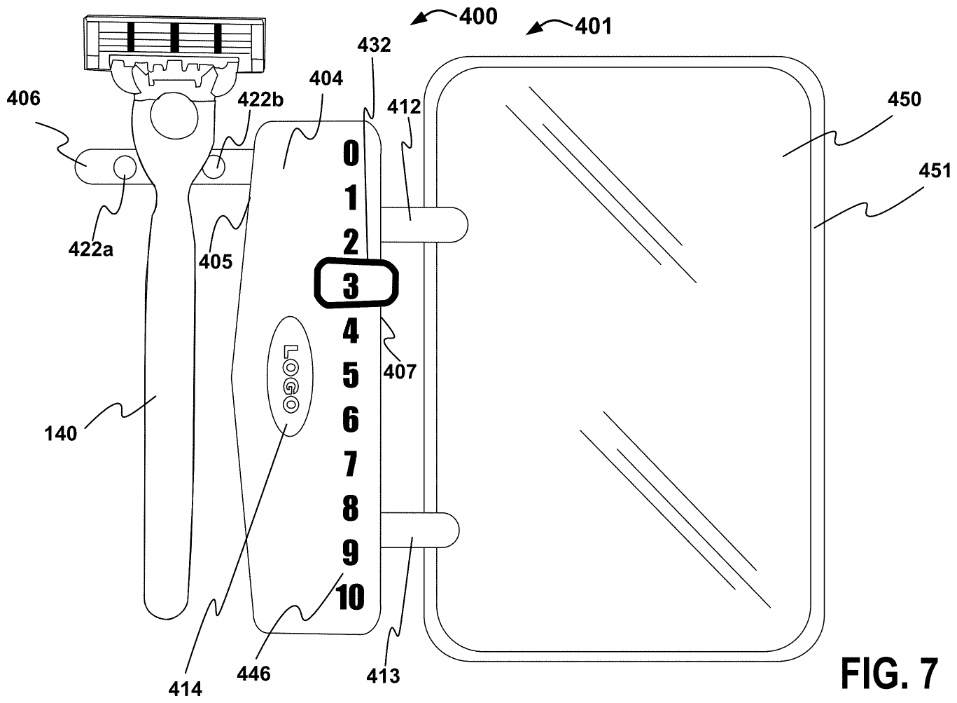

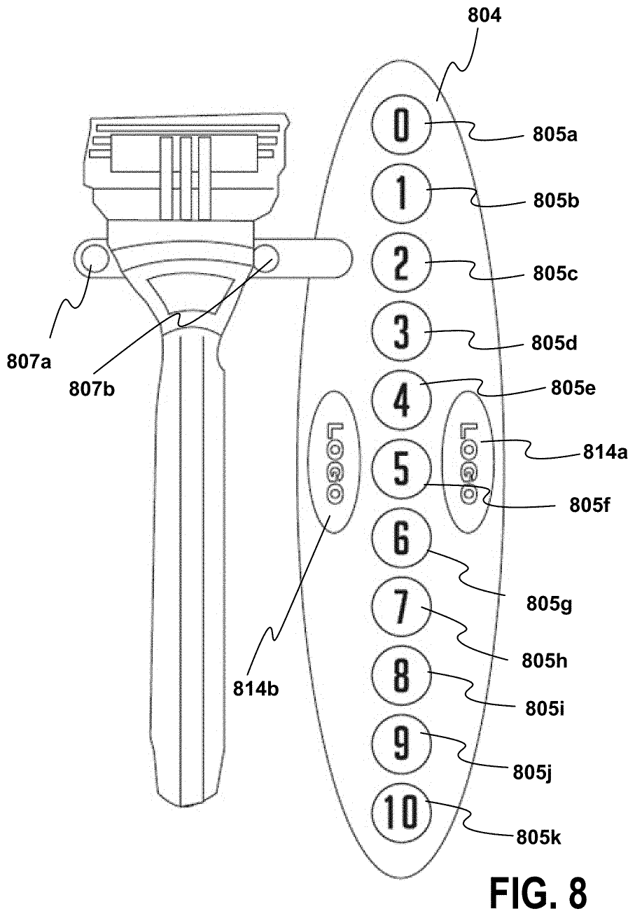

Several additional personal hygiene related counting devices are further contemplated by the developments hereof. For example, the personal hygiene counting device hereof may also include alternative embodiments such as using “radio buttons” that are numbered. In this implementation, the user would push or depress a radio button next to a number to indicate the count. The button would stay depressed (“pressed-in”) and previous button would return to an ejected status indicating that that previously pressed button is no long engaged or active for the count. This may be accomplished or configured using a serious of mechanically moveable and/or depressible buttons, buttonholes, springs, and the like. This implementation may be similar to old AM/FM radios. An example of such an apparatus is provided in FIG. 8. The device may have a body portion 804, depressible buttons 805a, 805b, 805c, 805d, 805e, 805f, 805g, 805h, 805i, 805j, and 805k, support arms 807a/807b, and one or more advertising spaces 814a/814b.

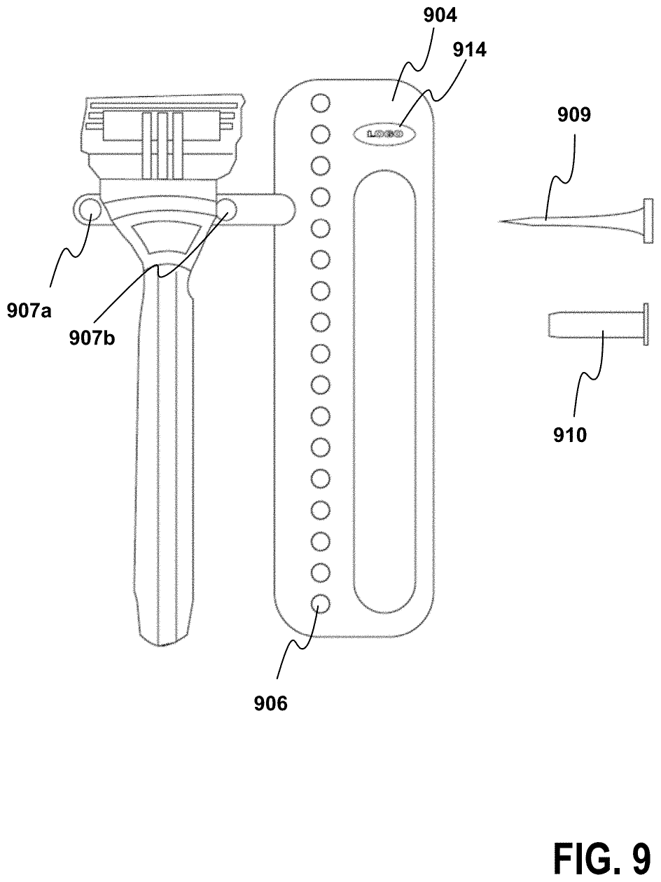

Another implementation contemplated by the developments hereof includes a hole and peg system where the body portion includes a designated number of holes a single peg is inserted into a numbered hole to track usage. The peg could be, for example, a golf tee and thus the personal hygiene device and associated counting device could be golf themed. An example of such an apparatus is shown in FIG. 9. In FIG. 9, the device has a body portion 904, tracking or counting holes 906, clasping arms 907a/907b, a golf tee 909, and an advertising space 914. Alternatively, the peg could be a bullet shell casing 910 and the body portion could be real or faux wood, and tailored and designed for the outdoor demographic.

Another implementation contemplated by the developments hereof includes a slide rule method wherein the user would move a sliding marker from one side to the other to count the activity, for example the number of shaves.

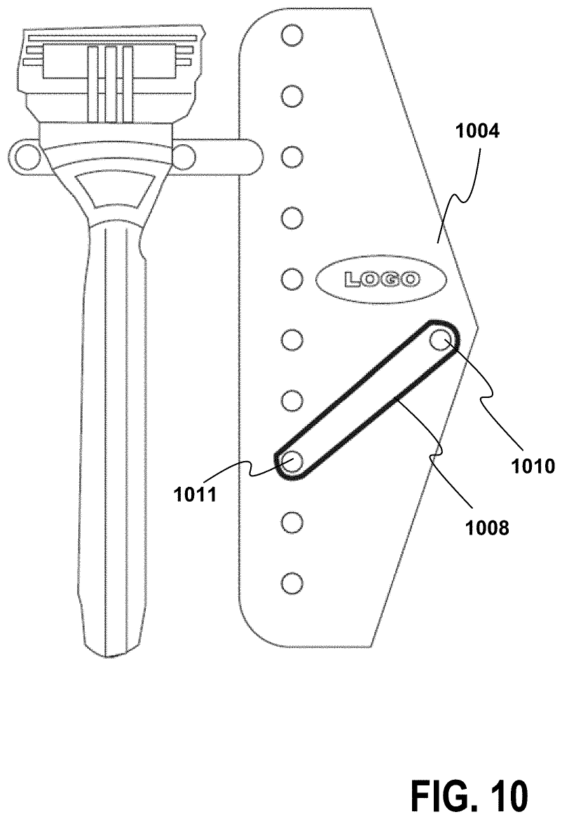

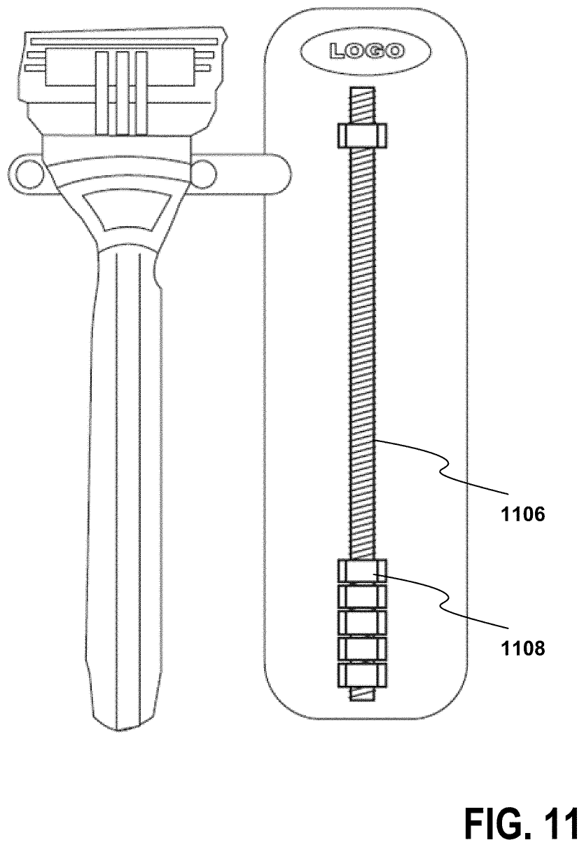

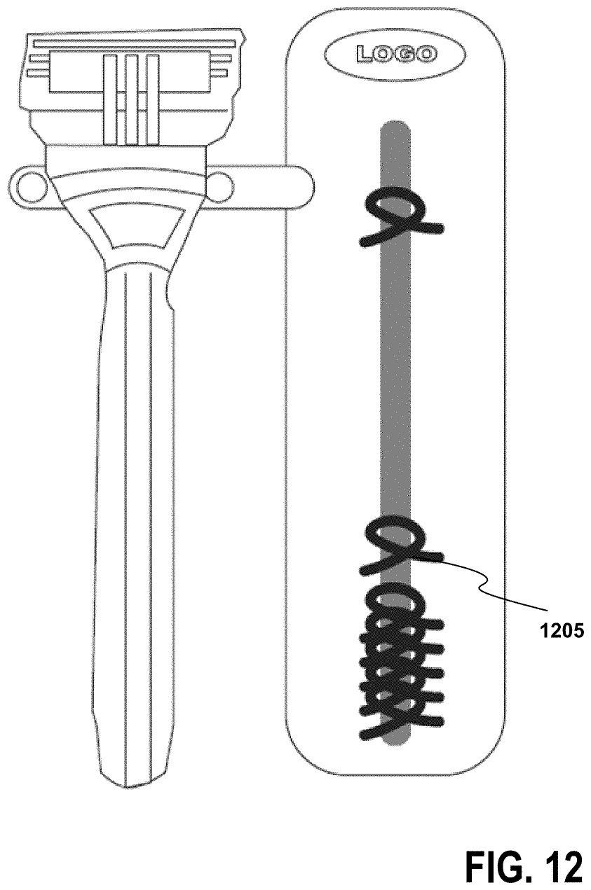

Yet another implementation contemplated by the developments hereof includes a rubber band related device and/or method. In this example, a user stretches rubber bands between numbered pegs that are in set locations on the body portion of the device. By stretching rubber bands 1008 from one peg 1010 to another peg 1011 located on the body portion 1004 the user may be able to visually represent an accurate count of the personal hygiene related activity. Such a device is disclosed and illustrated in FIG. 10. Another implementation contemplated is to use a piece of thereaded rod 1106 with nuts 1108 on it. The user would spin the nuts from one side of the device to the other, one at a time to represent the count. An example of an implementation utilizing a threaded rod and nuts is provided in FIG. 11. Yet another implementation utilizes a rope or shoestring 1205 that an individual ties knots on. The user would then move a knot from one side to the other to track the count related to the activity sought to be counted such as shaving, an example of implementation utilizing these materials and methods is illustrated and provided in FIG. 12.

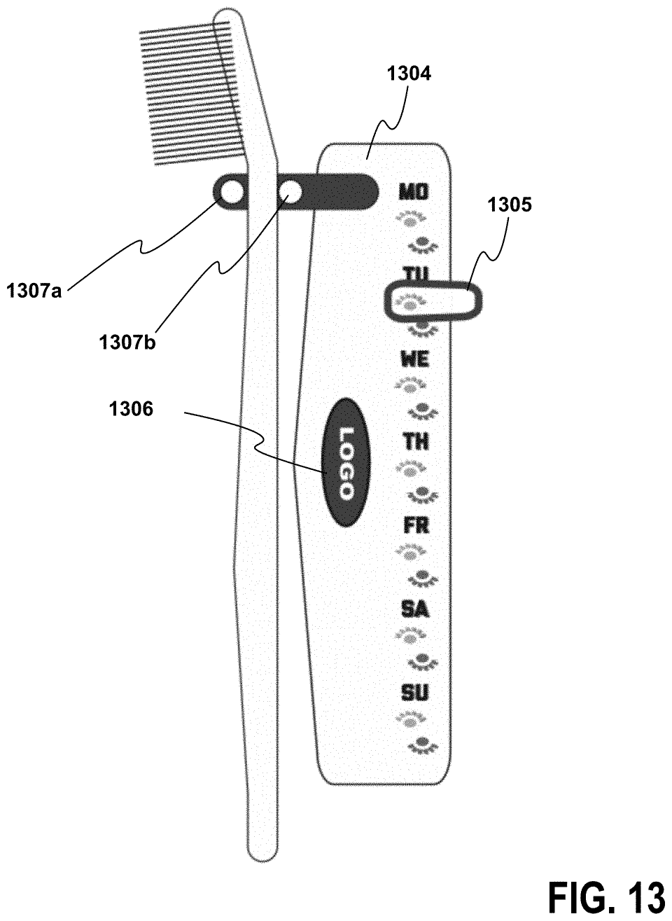

FIG. 13 provides yet another alternative implementation of a personal hygiene device that may be used by a child or an aging adult to help count and track a personal hygiene activity such as brushing one's teeth. The apparatus may have a body portion 1304, a sliding element 1305, an advertising space 1306, and supporting/clasping arms 1307a/1307b.

Some implementations and combinations of the device hereof have a body portion that has additional optional attachments, such as a mirror, a razor handle holder, a razor cartridge holder, toothbrush holder, personal care item holder, and/or a universal shelf.

An additional implementation hereof may be a device that plugs in to an electrical outlet. In this way, the support and mounting for the device comes from the prongs for an electrical socket. The body portion may have a shelf or protecting ledge that lays across the top of the body portion that would help to keep any water away that may be associated with the personal hygiene device away from the electrical outlet. Furthermore, in this implementation, a night-light could be incorporated into the body portion of the device which could provide illumination for the user in his/her bathroom environment. Additionally, in this implementation an LED or other light may be utilized to illuminate an advertising display, or provide a backlight to an image, or accentuate a design, logo, or branding. Furthermore, this implementation may exist with or without a counting device, an advertising display, an optional shelf, and/or other features that have been described herein.

In some implementations hereof, a company logo, image, or advertisement is integrated into the counter, counting elements, or other places on the device to promote or designate a brand. Moreover, the counting device hereof may be attached to a surface with suction cups, double sided adhesive tape, or could be freestanding.

The personal hygiene device hereof may be made of easily moldable material, including the body potion, the support areas, and the holding arms. Often times the apparatus is formed of die cut resilient material, so that the body portion, advertising display, holding arms, and support surface areas may be made in a variety of colors, and adapted to bear advertising or branding molded in to the surface of the apparatus.

Apparatuses hereof may be made by any of a variety of methods and/or a variety of materials. In many instances, impact resistant and/or ultraviolet (UV) stable resin or material may be selected. Plastics molded to integral or unitary forms as shown herein may be typical, though other forms and materials may be used as well. Sonic welding and/or glues and epoxies may be used to achieve certain combinations of shapes as well. Moreover, any of many alternative colors and/or colors schemes may be used, whether for matching to branding for example of a sports team, or television show, or other promotional material, or to match with bathroom décor. Shapes and sizes are not limited to those shown and described here either, as sizes and shapes may be selected to adapt to any of many different styles and preferences. Also, embossing and/or debossing of messages, logos, or alternative communicative features, as part of the manufacturing process on any one or more surfaces may also be used.

Although the present developments have been described with reference to preferred implementations, workers skilled in the art will recognize that one or more changes may be made in form and/or detail without departing from the spirit and scope of the claimed inventions.

From the foregoing, it is readily apparent that new and useful implementations of the present apparatus and/or methods have been herein described and illustrated which fulfill numerous desiderata. It is, of course, understood that such modifications, alterations, and adaptations as can readily occur to the artisan confronted with this disclosure are intended within the spirit of this disclosure which is limited only by the scope of the claims appended hereto.

What is claimed:

1. An apparatus comprising:
a body portion having a front side, a back side, and at least one mounting surface thereon, the body portion being adapted to be connected or disposed on a support structure via the at least one mounting surface;
the body portion having one or more supporting members connected thereto and projecting therefrom, the projecting member being adapted to receive and support a personal hygiene instrument, the body portion further having one or more moveable counting elements disposed on the front side of the body portion;
the mounting surface being adapted to receive and connect to one or more attachment elements via a cooperative connectability to secure the body portion to the support structure.

2. The apparatus of claim 1, wherein the mounting surface is adapted to be cooperatively connected to suction cups, double-sided tape, Velcro®, high tack adhesive or glue, or mounting screws, bolts, or nails.

3. The apparatus of claim 1, wherein the support structure is porcelain tile, marble, granite, glass, mirror, vinyl, drywall, concrete, wood, or other solid surface.

4. The apparatus of claim 1, further comprising an advertising device or display panel.

5. The apparatus of claim 1, wherein the counting element is a rotatable counting wheel.

6. The apparatus of claim 1, wherein the counting element is a sliding element.

7. The apparatus of claim 6, wherein the body portion has one or more grooves or channels for aligning and controlling the sliding element.

8. The apparatus of claim 1, wherein the body portion and the attachment are each made of one or the other of a moldable material and a die-cut material.

9. The apparatus of claim 1, further comprising horizontal support members.

10. The apparatus of claim 9, wherein the horizontal members support a mirror attachment.

11. A method for counting personal hygiene activities, comprising:
attaching to a wall a combination counting device and personal hygiene device holder;
utilizing the personal hygiene device;
counting the utilization of the personal hygiene device.

12. A method according to claim 11 further comprising:
repeating the utilizing operation; and,
repeating the counting operation.

13. A method according to claim 11, the personal hygiene device being either or both of a razor and/or a toothbrush.

14. (canceled)

15. (canceled)

16. The apparatus of claim 1 wherein the personal hygiene instrument is a razor and/or a toothbrush.

17. A method according to claim 12, the personal hygiene device being either or both of a razor and/or a toothbrush.
